(19) United States
(12) Patent Application Publication
(10) Pub. No.: US 2026/0235728 A1
(43) Pub. Date: Aug. 13, 2026

(54) TRANSCEIVER MODULE AND LIDAR

(71) Applicant: SUTENG INNOVATION TECHNOLOGY CO., LTD., Shenzhen (CN)

(72) Inventors: Jiachao ZHANG, Shenzhen (CN); Shihao LIU, Shenzhen (CN)

(73) Assignee: SUTENG INNOVATION TECHNOLOGY CO., LTD., Shenzhen (CN)

(21) Appl. No.: 19/467,711

(22) Filed: Feb. 2, 2026

(30) Foreign Application Priority Data
Feb. 7, 2025 (CN) 202510144542.4

(51) Int. Cl. G01S 7/481

(52) U.S. Cl. CPC G01S 7/4813

(57) ABSTRACT

A transceiver module includes at least one transmitting lens assembly, at least one receiving lens assembly, and a light-blocking member. The transmitting lens assembly has a light-exiting surface. The receiving lens assembly has a light-incident surface and is spaced apart from the transmitting lens assembly. A receiving field of view of the receiving lens assembly and a transmitting field of view of the transmitting lens assembly have an overlapping region. The light-blocking member is located between the light-exiting surface and the light-incident surface, and at least a portion of the light-blocking member is located in the overlapping region and disposed adjacent to at least one of the light-exiting surface or the light-incident surface. By providing the light-blocking member, the light-blocking member can block laser light emitted from the light-exiting surface from incident on the light-incident surface.

### CROSS-REFERENCE TO RELATED APPLICATION

The present application claims the benefit of priority to Chinese Patent Application No. 202510144542.4, filed on February 7, 2025, which is hereby incorporated by reference in its entirety.

### TECHNICAL FIELD

The present application relates to the technical field of radar, and in particular, to a transceiver module and a LiDAR.

### BACKGROUND

LiDAR is a radar system that emits laser beams to detect target characteristics such as position and velocity. Its working principle involves first emitting a detection laser beam towards a target, then comparing the received signal reflected back from the target with the transmitted signal. After appropriate processing, relevant information about the target can be obtained, such as parameters including target distance, azimuth, velocity, and attitude.

In related art, a LiDAR may include a transmitting device and a receiving device. The transmitting device has a transmitting field of view, and the receiving device has a receiving field of view. Herein, the transmitting field of view and the receiving field of view may partially overlap. Consequently, when there are attached substances such as rain or dust, light reflected by these attached substances may be unavoidably converted into stray light within the receiving device, thereby affecting the normal detection function of the LiDAR.

### SUMMARY

An embodiment of the present application provides a transceiver module, aiming to reduce the generation of stray light.

A first aspect of the embodiments of the present application provides a transceiver module. The transceiver module is applied to a LiDAR. The transceiver module includes at least one transmitting lens assembly, at least one receiving lens assembly, and a light-blocking member. The transmitting lens assembly has a light-exiting surface. The receiving lens assembly has a light-incident surface, and the receiving lens assembly is spaced apart from the transmitting lens assembly. A receiving field of view of the receiving lens assembly and a transmitting field of view of the transmitting lens assembly have an overlapping region. The light-blocking member is located between the light-exiting surface and the light-incident surface, and at least a portion of the light-blocking member is located in the overlapping region and disposed adjacent to the light-exiting surface and/or the light-incident surface, so as to block laser light emitted from the light-exiting surface from incident on the light-incident surface.

In some embodiments, the transmitting lens assembly includes a transmitting lens and a light-exiting window plate disposed on a light-exiting side of the transmitting lens. A surface of the light-exiting window plate facing away from the transmitting lens is the light-exiting surface. The receiving lens assembly includes a receiving lens and a light-incident window plate disposed on a light-incident side of the receiving lens. A surface of the light-incident window plate facing away from the receiving lens is the light-incident surface. The light-exiting window plate and the light-incident window plate are spaced apart. The light-blocking member is disposed between the light-incident window plate and the light-exiting window plate, and protrudes relative to both the light-exiting surface and the light-incident surface.

In some embodiments, a protruding height of the light-blocking member relative to the light-exiting surface is not greater than 3mm; and/or, a protruding height of the light-blocking member relative to the light-incident surface is not greater than 3mm.

In some embodiments, the light-blocking member has a top end protruding relative to the light-exiting surface. An end surface of the top end is an arc-shaped surface or a conical surface protruding away from the light-exiting surface, or, the end surface of the top end has one or more arc-shaped grooves concave toward the light-exiting surface, or, the end surface of the top end has one or more conical grooves concave toward the light-exiting surface.

In some embodiments, an extending direction of a length of the light-blocking member is perpendicular to an optical axis of the transmitting lens assembly; and/or, the light-exiting surface and the light-incident surface are coplanar.

In some embodiments, a hydrophobic layer is disposed on the light-exiting surface and/or the light-incident surface.

In some embodiments, the hydrophobic layer includes one of an organic silicon layer, an organic fluorine layer, and a nano-metal oxide layer; and/or, a contact angle of the hydrophobic layer is greater than 90 degrees.

In some embodiments, a hydrophilic layer is disposed on at least a surface of a portion of the light-blocking member protruding from the light-exiting surface and the light-incident surface.

In some embodiments, the hydrophilic layer includes one of a passivation layer, an anodized layer, and a paint layer; and/or, a contact angle of the hydrophilic layer is less than 60 degrees.

In some embodiments, the transceiver module further includes a bracket. The transmitting lens, the light-exiting window plate, the receiving lens, and the light-incident window plate are all mounted on the bracket. The light-blocking member and the bracket are an integrated component, or, the light-blocking member and the bracket are separate components, and the light-blocking member is mounted on the bracket.

In some embodiments, the light-exiting window plate and the light-incident window plate are fixed to the bracket by adhesive bonding or pressing.

In some embodiments, the transmitting lens assembly includes a transmitting lens, the receiving lens assembly includes a receiving lens. The transceiver module further includes a shared window plate. The shared window plate is disposed on a light-exiting side of the transmitting lens and a light-incident side of the receiving lens, and has the light-exiting surface and the light-incident surface. The light-blocking member penetrates the shared window plate, protrudes relative to both the light-exiting surface and the light-incident surface, and is located between the transmitting lens and the receiving lens.

In some embodiments, the transmitting lens assembly includes a transmitting lens. The transmitting lens includes a transmitting lens barrel and a light-exiting lens mounted in the transmitting lens barrel. An outer surface of an outermost light-exiting lens is the light-exiting surface. The receiving lens assembly includes a receiving lens. The receiving lens includes a receiving lens barrel and a light-incident lens mounted in the receiving lens barrel. An outer surface of an outermost light-incident lens is the light-incident surface. The light-blocking member includes a portion of the transmitting lens barrel protruding from the light-exiting surface; and/or, the light-blocking member includes a portion of the receiving lens barrel protruding from the light-incident surface.

In some embodiments, the transceiver module further includes a bracket. The transmitting lens and the receiving lens are both mounted on the bracket. Along a light-exiting direction of the transmitting lens, a first distance exists between the light-exiting surface and the bracket, and the first distance is not less than 2mm.

In some embodiments, at least one of the transmitting lens assembly and the receiving lens assembly is plural in number. When the number of the transmitting lens assemblies is two, the two transmitting lens assemblies are located on opposite sides of one receiving lens assembly. One light-blocking member is located between one light-exiting surface and the light-incident surface, and another light-blocking member is located between the other light-exiting surface and the light-incident surface.

A second aspect of the embodiments of the present application provides a LiDAR. The LiDAR includes a housing and the transceiver module according to any one of the above embodiments. The transceiver module is mounted on the housing.

The embodiments of the present application, by disposing the light-blocking member between the light-exiting surface and the light-incident surface, cause the light-blocking member to block the laser light emitted from the light-exiting surface from incident on the light-incident surface. In this way, when an attached substance adheres to the overlapping portion of the transmitting field of view and the receiving field of view, since the light-blocking member partitions the overlapping portion of the transmitting field of view and the receiving field of view, the laser light reflected by the attached substance will not enter the light-incident surface. Thereby, the generation of stray light is reduced, the detection accuracy and stability of the LiDAR are improved, and thus the performance of the LiDAR is enhanced.

### BRIEF DESCRIPTION OF DRAWINGS

To illustrate the embodiments of the present application or the technical solutions in the related art more clearly, the following briefly introduces the accompanying drawings. Obviously, the accompanying drawings in the following description merely show some embodiments of the present application. For a person skilled in the art, other drawings can be obtained from these accompanying drawings without inventive effort.

FIG. 1 is a block diagram of a LiDAR according to an embodiment of the present application;

FIG. 2 is an exploded schematic structural view of a transceiver module according to an embodiment of the present application;

FIG. 3 is another exploded schematic structural view of a transceiver module according to an embodiment of the present application;

FIG. 4a and FIG. 4b are schematic diagrams of dynamic testing according to an embodiment of the present application;

FIG. 5 is a schematic structural view of a movable device according to an embodiment of the present application;

FIG. 6a and FIG. 6b are front views of measured data in the absence of rain according to an embodiment of the present application;

FIG. 7a and FIG. 7b are front views of measured data in the presence of rain according to an embodiment of the present application;

FIG. 8a and FIG. 8b are top views of measured data in the presence of rain according to an embodiment of the present application;

FIG. 9 is another perspective schematic structural view of a transceiver module according to an embodiment of the present application;

FIG. 10 is a sectional view taken along line A-A in FIG. 9;

FIG. 11 is a first schematic structural view of a light-blocking member according to an embodiment of the present application;

FIG. 12 is a second schematic structural view of a light-blocking member according to an embodiment of the present application;

FIG. 13 is a third schematic structural view of a light-blocking member according to an embodiment of the present application;

FIG. 14 is a fourth schematic structural view of a light-blocking member according to an embodiment of the present application; and

FIG. 15 is yet another perspective schematic structural view of a transceiver module according to an embodiment of the present application.

Description of reference numerals: 1: LiDAR; 2: movable device; 3: device body; 10: housing; 20: transceiver module; 21: transmitting lens assembly; 211: light-exiting surface; 212: transmitting lens; 2121: transmitting lens barrel; 2122: light-exiting lens; 213: light-exiting window plate; 22: receiving lens assembly; 221: light-incident surface; 222: receiving lens; 2221: receiving lens barrel; 2222: light-incident lens; 223: light-incident window plate; 23: light-blocking member; 231: conical groove; 24: bracket; 241: mounting hole.

### DETAILED DESCRIPTION

To make the objectives, technical solutions, and advantages of the present application clearer, the following further describes the present application in detail with reference to the accompanying drawings and embodiments. It should be understood that the specific embodiments described herein are merely intended to explain the present application and are not intended to limit the present application.

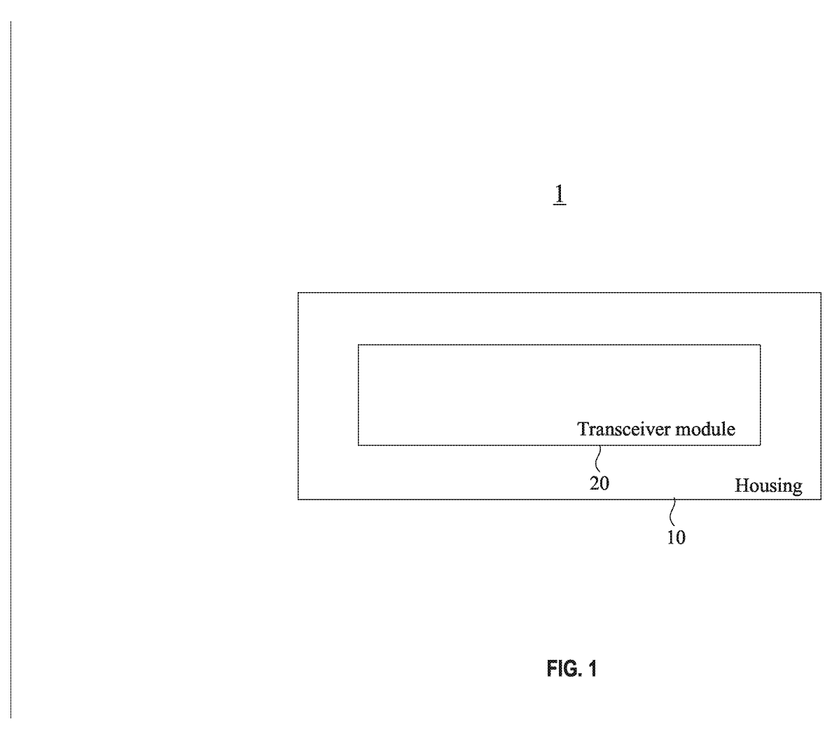

Please refer to FIG. 1. An embodiment of the present application provides a LiDAR 1. LiDAR 1 is an advanced sensing technology that emits laser beams to detect target characteristics such as position and velocity. LiDAR 1 can be applied in fields such as autonomous vehicles, robot navigation, and unmanned aerial vehicle (UAV) applications. The LiDAR 1 may include a housing 10 and a transceiver module 20.

Specifically, the transceiver module 20 is mounted on the housing 10, allowing the housing 10 to protect the transceiver module 20. Therefore, the housing 10 needs to be made of high-strength and corrosion-resistant materials to ensure stable operation of the LiDAR 1 in various harsh environments. Furthermore, to prevent moisture, dust, and other impurities from entering the interior of the LiDAR 1, the housing 10 needs to have good sealing performance. For example, technologies such as welded breathable membranes can be used to achieve dustproof and waterproof performance for the housing 10. Additionally, since the transceiver module 20 generates a certain amount of heat during operation, heat dissipation performance needs to be considered in the design of the housing 10 to ensure that the transceiver module 20 can operate stably even in high-temperature environments.

The transceiver module 20 is the core component of the LiDAR 1, and it is responsible for the emission and reception of laser light.

The transceiver module 20 is described in detail below.

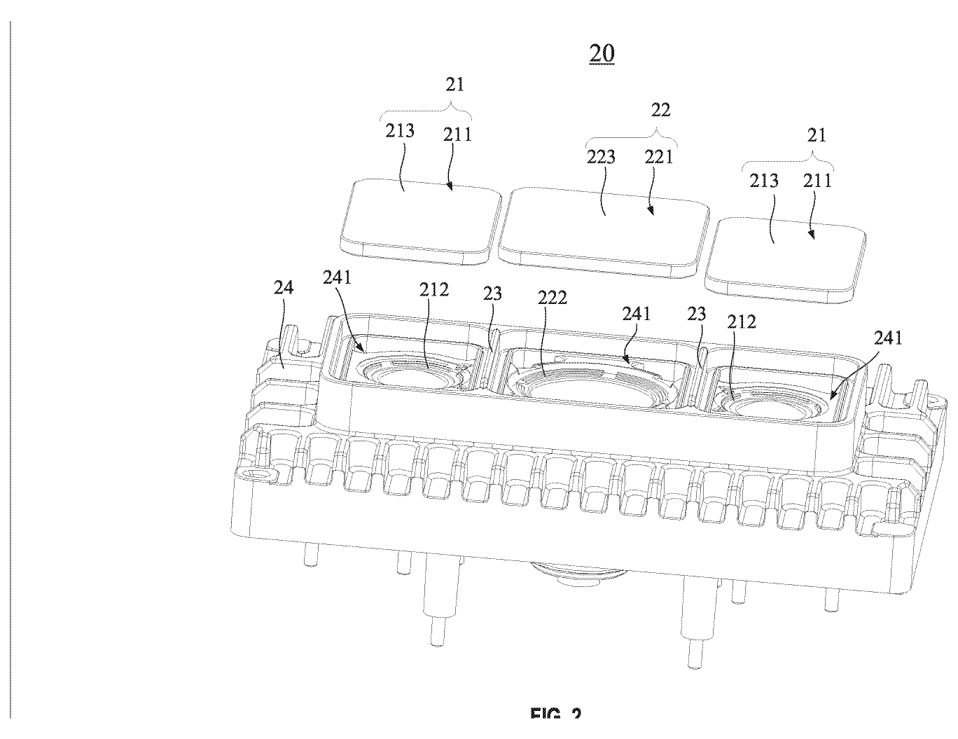

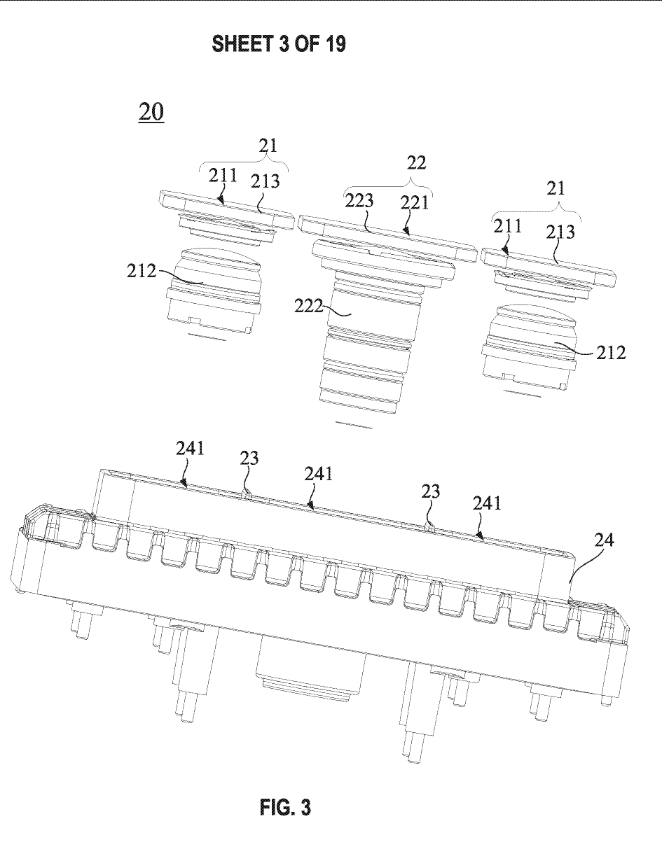

Please refer to FIGS. 2 and 3. The transceiver module 20 includes at least one transmitting lens assembly 21 and at least one receiving lens assembly 22. That is, the number of transmitting lens assemblies 21 can be one or multiple, and the number of receiving lens assemblies 22 can also be one or multiple. The embodiments of the present application do not specifically limit the quantitative relationship between the transmitting lens assemblies 21 and the receiving lens assemblies 22. That is, when the number of transmitting lens assemblies 21 is one, the number of receiving lens assemblies 22 can be one or multiple; when the number of transmitting lens assemblies 21 is multiple, the number of receiving lens assemblies 22 can be one or multiple. Among them, the main function of the transmitting lens assembly 21 is to collimate and focus the generated laser beam before emitting it; the main function of the receiving lens assembly 22 is to receive the laser signal reflected back from the target object and focus it onto a photodetector. The photodetector processes the received laser signal and sends it to the system of the LiDAR 1 to obtain the required information about the target.

The transmitting lens assembly 21 has a light-exiting surface 211, and the receiving lens assembly 22 has a light-incident surface 221. It can be understood that the light-exiting surface 211 is the interface through which the laser signal is emitted from the interior of the LiDAR 1 to the external environment; the light-incident surface 221 is the interface for receiving the laser signal reflected back from the target object. Furthermore, the receiving lens assembly 22 is spaced apart from the transmitting lens assembly 21, and a receiving field of view of the receiving lens assembly 22 and a transmitting field of view of the transmitting lens assembly 21 have an overlapping region. It should be noted that the embodiments of the present application do not specifically limit the separation distance between the receiving lens assembly 22 and the transmitting lens assembly 21. That is, the separation distance between the receiving lens assembly 22 and the transmitting lens assembly 21 needs to be precisely calculated and optimized according to parameters such as the operating wavelength of the LiDAR 1, the distance to the target object, and the emission rate.

Moreover, the smaller the separation distance between the receiving lens assembly 22 and the transmitting lens assembly 21, on the one hand, it can enable a better mapping relationship between the emission of the transmitting lens assembly 21 and the reception of the receiving lens assembly 22, thereby reducing the near-field blind zone of the radar and improving the detection performance; on the other hand, it can make the overall volume of the LiDAR 1 smaller.

However, in related art, when the separation distance between the transmitting lens assembly 21 and the receiving lens assembly 22 is small, it is prone to cause an increase in the overlapping portion of the transmitting field of view of the transmitting lens assembly 21 and the receiving field of view of the receiving lens assembly 22, i.e., the overlapping region increases. In such cases, when attached substances such as rainwater or dust adhere to the overlapping portion at close range, the laser beam emitted by the transmitting lens assembly 21 will be partially reflected back to the receiving lens assembly 22 upon encountering the attached substances, thereby forming stray light. Stray light affects the detection accuracy and stability of the LiDAR 1, leading to a decrease in the performance of the LiDAR 1.

Please continue to refer to FIGS. 2 and 3. Therefore, to solve the above problem, the transceiver module 20 of the embodiments of the present application further includes a light-blocking member 23. The light-blocking member 23 is located between the light-exiting surface 211 and the light-incident surface 221, and at least a portion of the light-blocking member 23 is located in the overlapping region and disposed adjacent to at least one of the light-exiting surface 211 and the light-incident surface 221. In this way, the light-blocking member 23 partitions the overlapping portion of the transmitting field of view and the receiving field of view, thereby blocking the laser light emitted from the light-exiting surface 211 from incident on the light-incident surface 221. That is, the light-blocking member 23 is disposed between the light-exiting surface 211 and the light-incident surface 221, so that both the light-exiting surface 211 and the light-incident surface 221 are independently formed, thereby reducing the transmission of the laser beam between the transmitting lens assembly 21 and the receiving lens assembly 22, and thus reducing the generation of stray light. Herein, the light-blocking member 23 needs to be configured to be opaque, so as to serve the function of blocking the laser light emitted from the light-exiting surface 211 from incident on the light-incident surface 221.

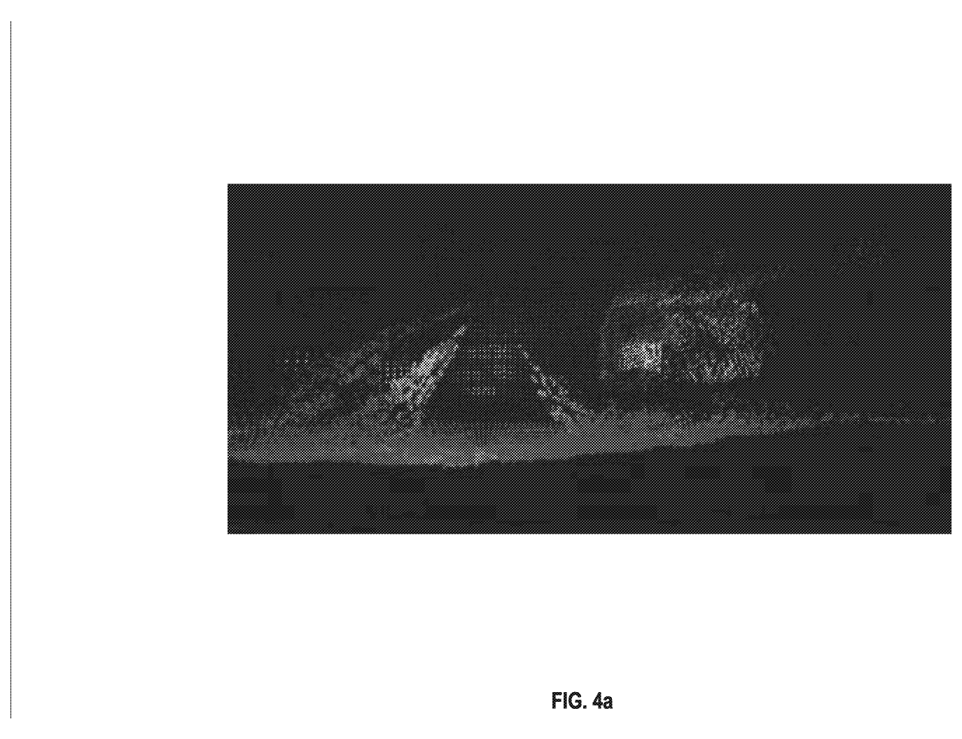

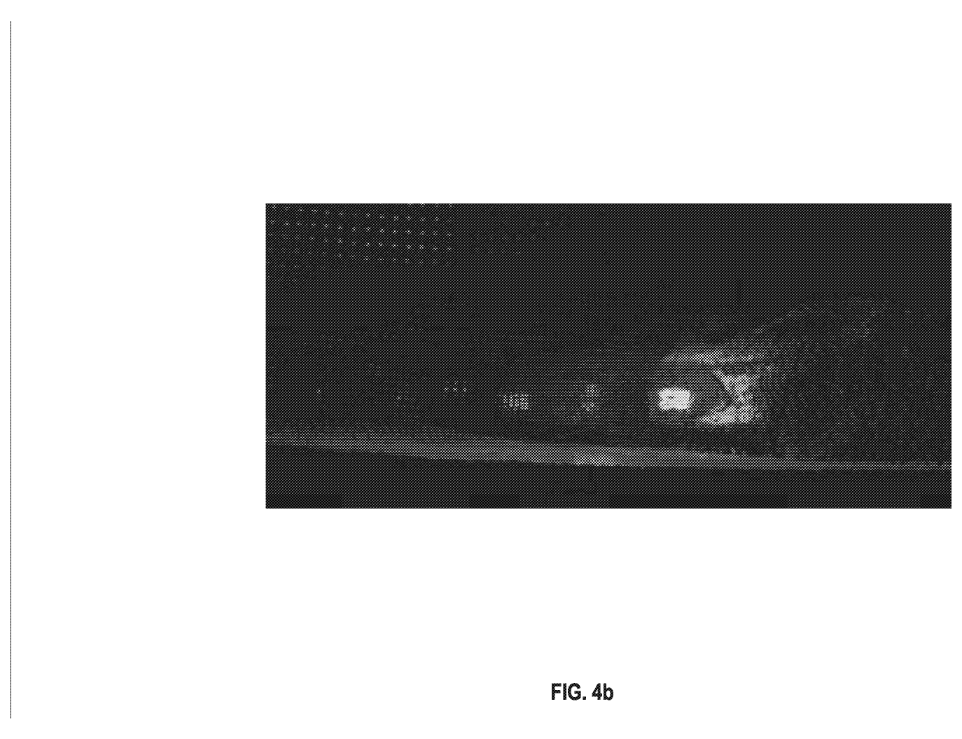

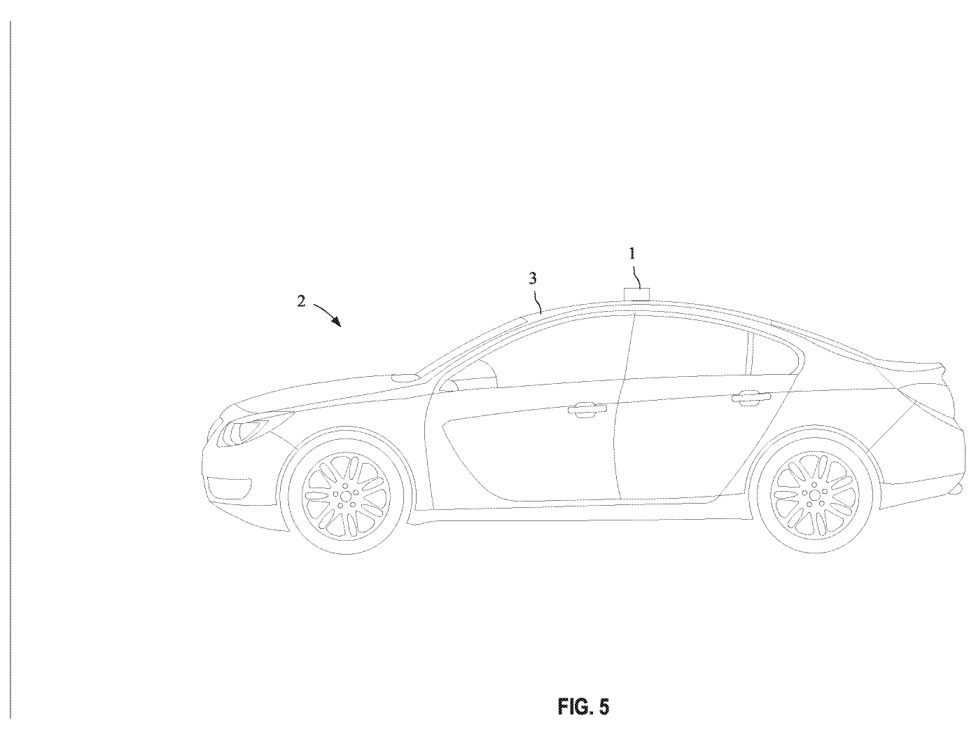

To demonstrate the usefulness of the light-blocking member 23 in the embodiments of the present application, please refer to FIGS. 4a, 4b, and 5. FIG. 5 shows testing conducted in combination with a movable device 2. The movable device 2 includes a device body 3 and the aforementioned LiDAR 1, and the device body 3 is connected to the LiDAR 1. In some embodiments, the movable device 2 is a vehicle, the device body 3 is the vehicle body, and the LiDAR 1 can be mounted on the vehicle body. The present application does not uniquely limit the position and quantity of the LiDAR 1 on the device body 3. For example, the LiDAR 1 can be disposed on the upper part of the device body 3, or on the side of the device body 3, or on the front side of the device body 3. The present application does not impose any specific restriction on this. For another example, the number of LiDAR 1 included in the device body 3 can be 1, 2, or more. The present application does not impose any specific restriction on this. It can be understood that multiple LiDAR 1 can be distributed disposed at different positions on the device body 3; or multiple LiDAR 1 can also be disposed at the same position on the device body 3. The present application does not impose any specific restriction on this. Further, FIG. 4a is a dynamic test diagram without the light-blocking member 23. It can be seen from FIG. 4a that in the presence of rain, during the testing process of the LiDAR 1, due to rainwater adhering to the overlapping region of the transmitting field of view and the receiving field of view, it can be observed that point cloud information forms ghost points in ground areas, and some areas have voids. FIG. 4b is a dynamic test diagram with the light- blocking member 23, and since the light-blocking member 23 is provided in FIG. 4b, ghost points and missing detection information do not occur.

It should be noted that the present application does not limit the specific mounting position of the LiDAR 1. For example, the LiDAR 1 can also be disposed in front of, to the side of, or behind the movable device 2, etc. At the same time, in other embodiments of the present application, the movable device 2 can also be a device equipped with a LiDAR 1 other than a vehicle, such as a UAV, a robot, etc., which is not limited by the present application.

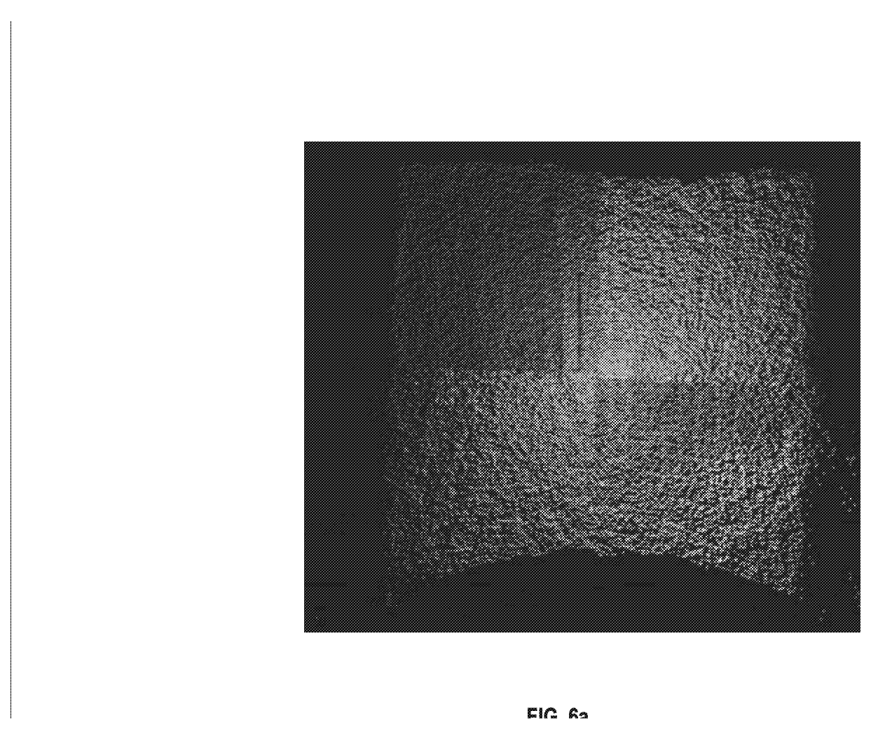

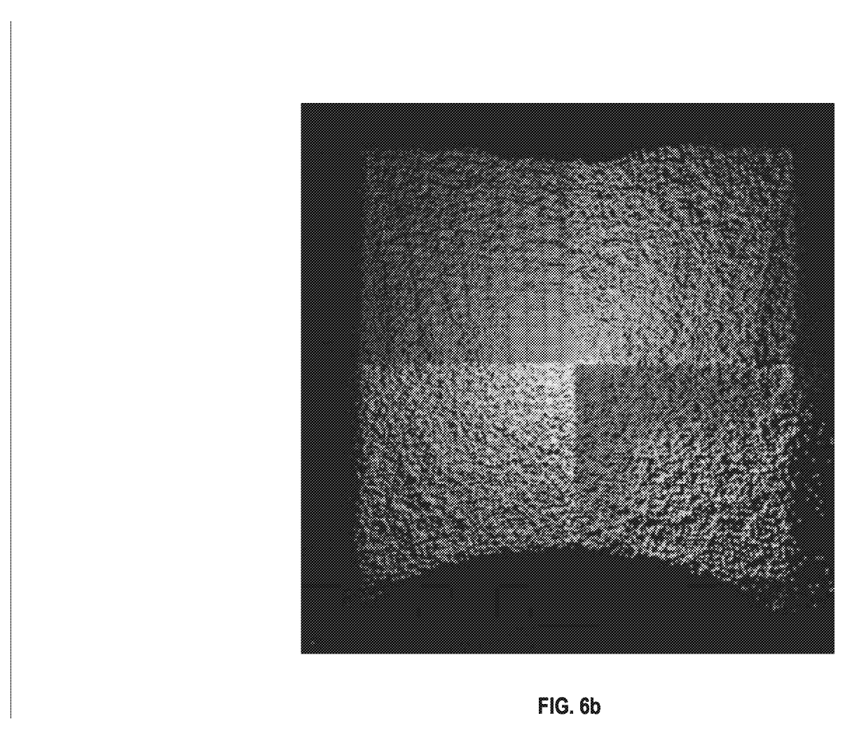

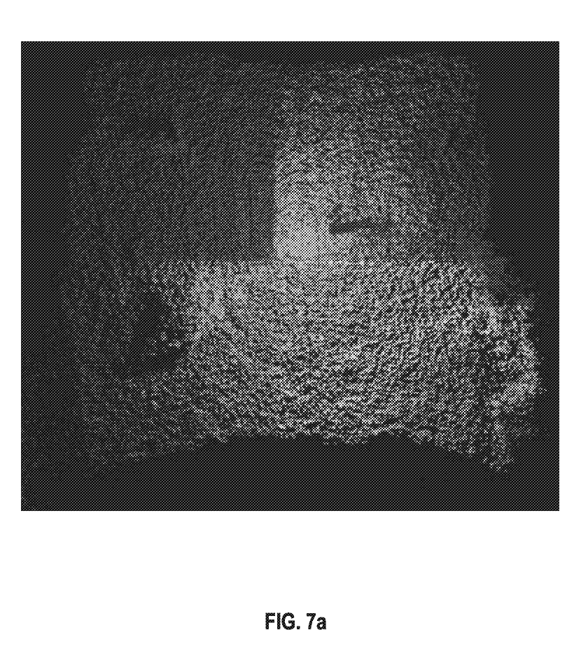

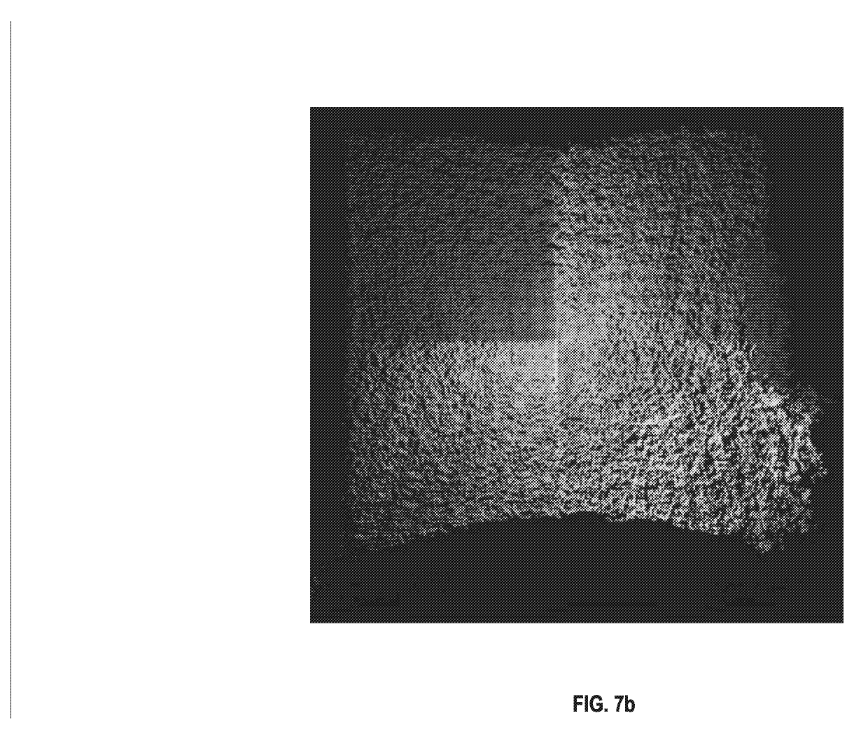

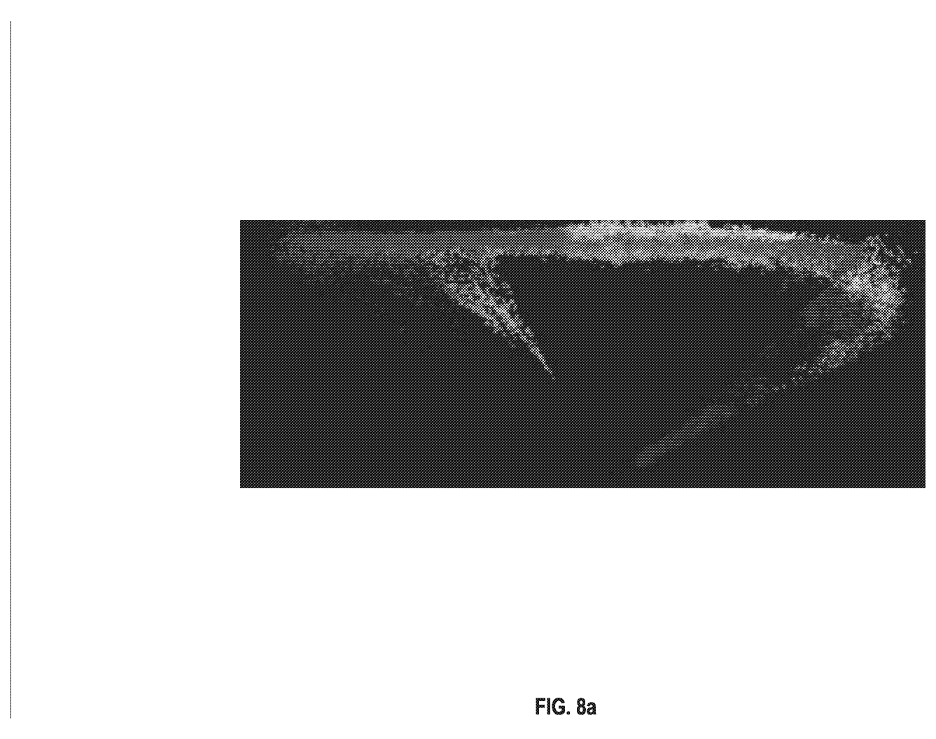

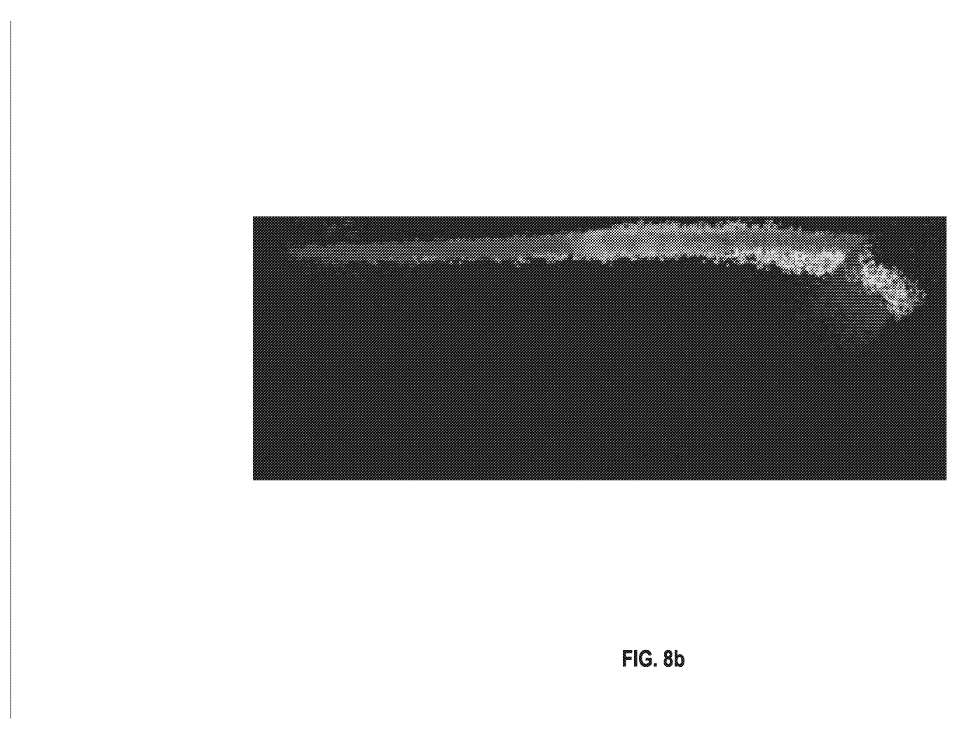

Further, referring to FIGS. 6a to 8b, it can be seen from FIGS. 6a and 6b that in the absence of rain, the presence or absence of the light-blocking member 23 has little impact on the measured data of the LiDAR 1. In the presence of rain, FIG. 7a is a front view of measured data without the light-blocking member 23. It can be seen from FIG. 7a that when the light-blocking member 23 is not provided, the LiDAR 1, affected by rain, forms multiple voids, thereby affecting the detection accuracy of the LiDAR 1. FIG. 7b is a front view of measured data with the light-blocking member 23. It can be seen from FIG. 7b that even in the presence of rain, multiple voids are not formed in the measured data of the LiDAR 1 because the light-blocking member 23 is disposed between the light-exiting surface 211 and the light-incident surface 221. Moreover, in the presence of rain, FIG. 8a is a top view of measured data without the light-blocking member 23. Since FIG. 8a does not have the light-blocking member 23, the LiDAR 1 is affected by rain, forming ghost points, and some measured signal data is missing. FIG. 8b is a top view of measured data with the light-blocking member 23. It can be seen from FIG. 8b that even in the presence of rain, ghost points and data missing do not occur in the measured data of the LiDAR 1 because the light-blocking member 23 is disposed between the light-exiting surface 211 and the light-incident surface 221. In summary, it can be concluded that the provision of the light-blocking member 23 can address the problem of degraded point cloud quality and reduced accuracy caused by the presence of rainwater or other attached substances in the overlapping field-of-view region of the radar's transmission and reception.

The embodiments of the present application, by disposing the light-blocking member 23 between the light-exiting surface 211 and the light-incident surface 221, cause the light-blocking member 23 to block the laser light emitted from the light-exiting surface 211 from incident on the light-incident surface 221. In this way, when an attached substance adheres to the overlapping portion of the transmitting field of view and the receiving field of view, since the light-blocking member 23 partitions the overlapping portion, the laser light reflected by the attached substance from the emitted laser will not enter the light-incident surface 221. Thereby, the generation of stray light is reduced, the detection accuracy and stability of the LiDAR 1 are improved, and thus the detection performance of the LiDAR 1 is enhanced.

Furthermore, the embodiments of the present application do not specifically limit the installation order between the transmitting lens assemblies 21 and the receiving lens assemblies 22. For example, when the number of transmitting lens assemblies 21 is two and the number of receiving lens assemblies 22 is one (as shown in FIG. 2), the two transmitting lens assemblies 21 are located on both sides of one receiving lens assembly 22. That is, the receiving lens assembly 22 is disposed between the two transmitting lens assemblies 21. To reduce mutual interference between the transmitting lens assemblies 21 and the receiving lens assembly 22, one light-blocking member 23 is located between one light-exiting surface 211 and the light-incident surface 221, and another light-blocking member 23 is located between the other light-exiting surface 211 and the light-incident surface 221. This can block the attached substances from reflecting laser light towards the receiving lens assembly 22, thereby reducing the entry of stray light into the receiving lens assembly, and thus reducing the impact of attached substances on detection performance.

In related art, to protect the transmitting lens assembly 21 and the receiving lens assembly 22, a window plate can be added to the transmitting lens assembly 21 and the receiving lens assembly 22. This window plate needs to meet the requirements of light transmission and protection. However, since the receiving lens assembly 22 and the transmitting lens assembly 21 share a common window plate, the laser light emitted by the transmitting lens assembly 21 can be transmitted to the receiving lens assembly 22 through multiple optical waveguides within the window plate, thereby generating stray light. Moreover, on the basis of the receiving lens assembly 22 and the transmitting lens assembly 21 sharing a common window plate, if attached substances such as rainwater or dust cover the window plate, the generation of stray light will be further intensified.

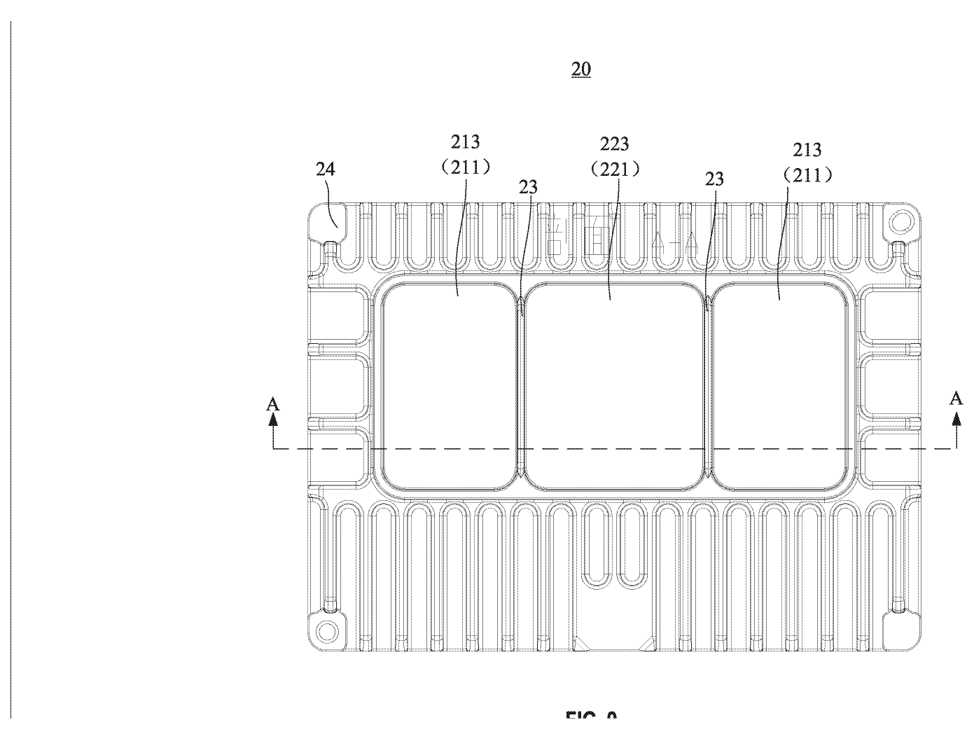

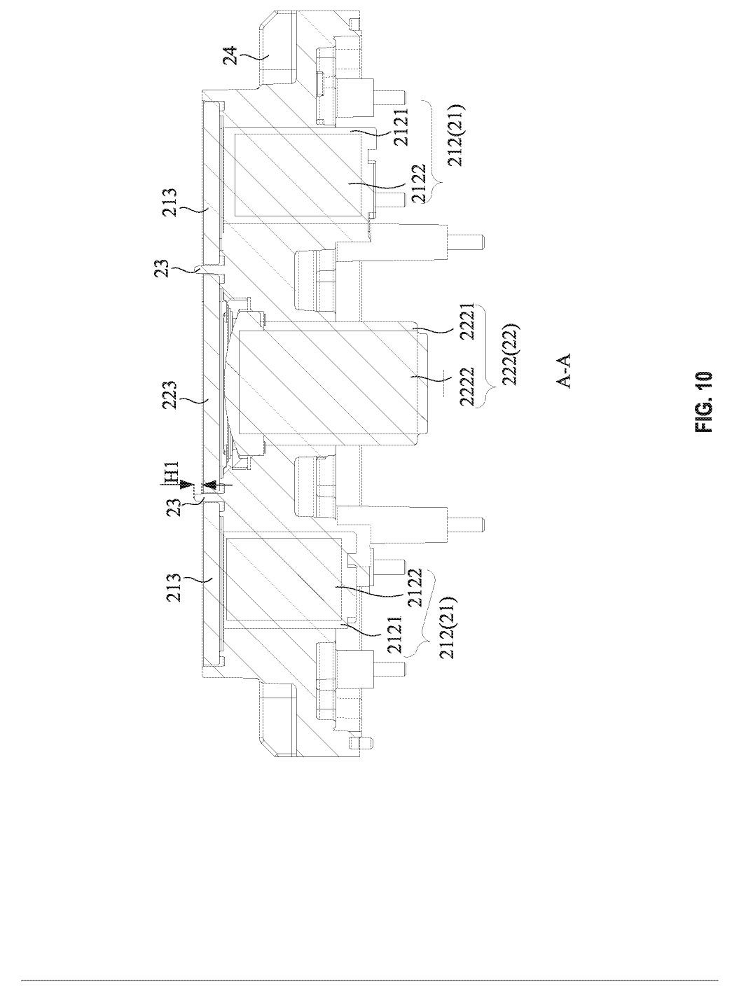

Please refer to FIGS. 9 and 10. Therefore, in some embodiments, the transmitting lens assembly 21 may include a transmitting lens 212 and a light-exiting window plate 213. The light-exiting window plate 213 is disposed on the light-exiting side of the transmitting lens 212, so that the surface of the light-exiting window plate 213 facing away from the transmitting lens 212 forms the light-exiting surface 211. The receiving lens assembly 22 includes a receiving lens 222 and a light-incident window plate 223. The light-incident window plate 223 is disposed on the light-incident side of the receiving lens 222, so that the surface of the light-incident window plate 223 facing away from the receiving lens 222 forms the light-incident surface 221. At this time, the light-exiting window plate 213 and the light-incident window plate 223 are spaced apart, and the light-blocking member 23 is disposed between the light-incident window plate 223 and the light-exiting window plate 213. It can be understood that the transmitting lens 212 is provided with a corresponding light-exiting window plate 213, and the receiving lens 222 is provided with a corresponding light-incident window plate 223. In this way, the transmitting lens 212 has an independent light-exiting window plate 213, and the receiving lens 222 has an independent light-incident window plate 223. Furthermore, the light-blocking member 23 is disposed between the light-incident window plate 223 and the light-exiting window plate 213, and the light-blocking member 23 can protrude relative to both the light-exiting surface 211 and the light-incident surface 221. This allows the light-blocking member 23 not only to serve the function of separating the light-incident window plate 223 and the light-exiting window plate 213 but also, to reduce the generation of stray light, to be configured to protrude relative to the light-exiting surface 211 and the light-incident surface 221.

Please refer to FIG. 10. Further, in some embodiments, a protruding height H1 of the light-blocking member 23 relative to the light-exiting surface 211 is not greater than 3mm, or a protruding height H1 of the light-blocking member 23 relative to the light-incident surface 221 is not greater than 3mm, or the protruding heights H1 of the light-blocking member 23 relative to both the light-exiting surface 211 and the light-incident surface 221 are not greater than 3mm. The embodiments of the present application do not specifically limit this. The following description uses the case where the protruding heights H1 of the light-blocking member 23 relative to both the light-exiting surface 211 and the light-incident surface 221 are not greater than 3mm as an example.

It can be understood that the protruding height H1 of the light-blocking member 23 relative to the light-exiting surface 211 and the light-incident surface 221 can be 1mm, 2mm, 3mm, etc. Specifically, the height by which the light-blocking member 23 protrudes from the light-exiting surface 211 is related to the degree of overlap between the transmitting and receiving fields of view. The higher the overlap between the transmitting and receiving fields of view, the higher the protruding height set for the light-blocking member. In this way, it can effectively reduce the emitted laser light from being reflected by attached substances on the light-incident window plate 223 or the light-exiting window plate 213 into the receiving lens assembly, thereby generating stray light. If the protruding height H1 of the light-blocking member 23 relative to the light-exiting surface 211 and the light-incident surface 221 is greater than 3mm, the protruding height H1 of the light-blocking member 23 is relatively high, which is prone to reduce the normal transmitting field of view of the transmitting lens assembly 21 and the normal receiving field of view of the receiving lens assembly 22, leading to a reduction in the detection range of the LiDAR 1 and thus causing detection blind zones in the LiDAR 1.

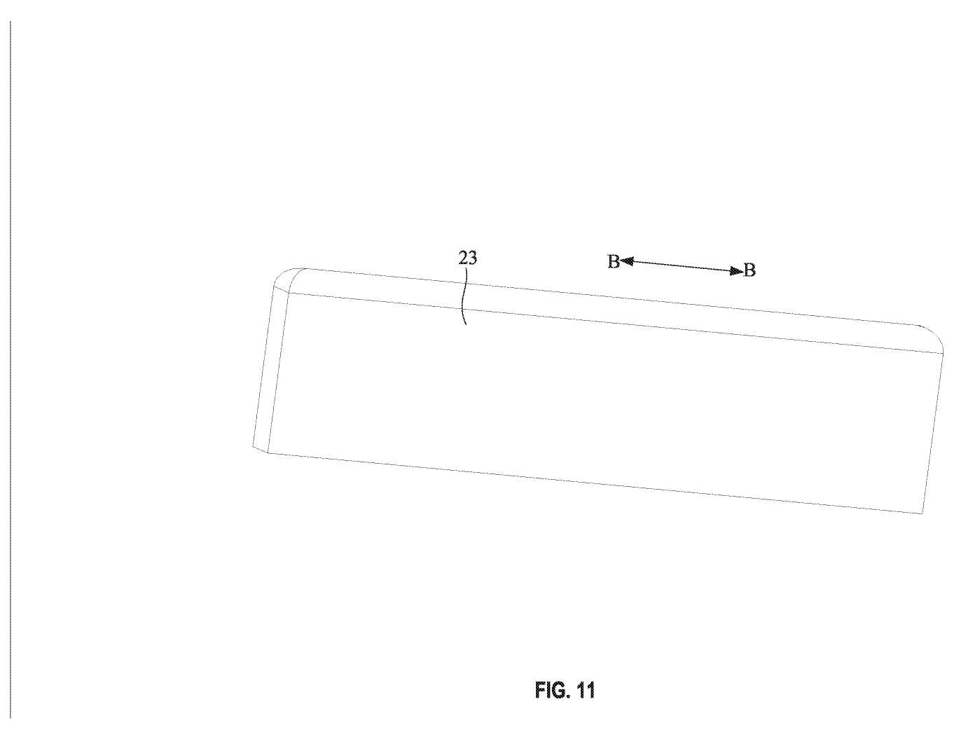

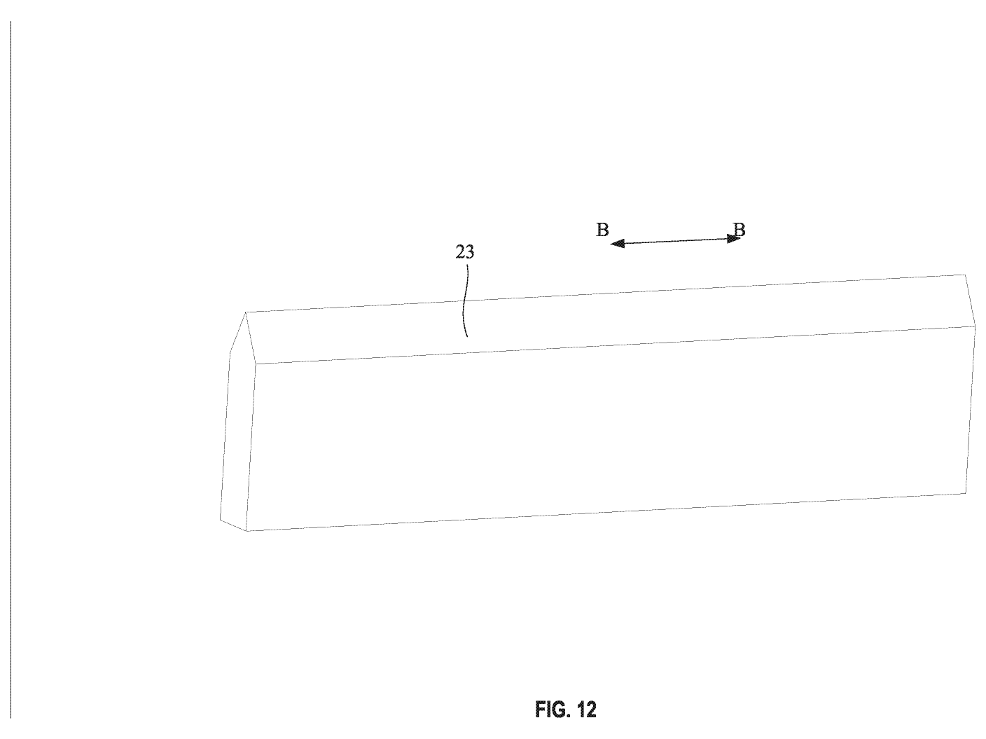

It should be noted that the light-blocking member 23 has a top end protruding relative to the light-exiting surface 211. The embodiments of the present application do not specifically limit the shape of the top end of the light-blocking member 23 that protrudes relative to the light-exiting surface 211. For example, please refer to FIGS. 11 and 12. The end surface of the top end is an arc-shaped surface or a conical surface protruding away from the light-exiting surface 211. That is, the protruding top end of the light-blocking member 23 is not a flat plane. In this way, when attached substances such as rainwater or dust fall onto the light-blocking member 23, since the end surface of the top end of the light-blocking member 23 is an arc-shaped surface or a conical surface protruding away from the light-exiting surface 211, the adhesion of attached substances to the end surface of the top end of the light-blocking member 23 can be reduced.

For example, the end surface of the top end has one or more arc-shaped grooves concave toward the light-exiting surface 211. In this way, when attached substances such as rainwater or dust fall onto the light-blocking member 23, since the end surface of the top end of the light-blocking member 23 has one or more arc-shaped grooves concave toward the light-exiting surface 211, the attached substances can be concealed within the arc-shaped grooves, reducing the reflection of laser light by the attached substances to the receiving lens 222, thereby reducing the generation of stray light. Moreover, the attached substances concealed within the arc-shaped grooves can flow out from both sides along the length extension direction BB of the light-blocking member 23, to prevent the attached substances from being stored in the arc-shaped grooves of the light-blocking member 23 for a long time.

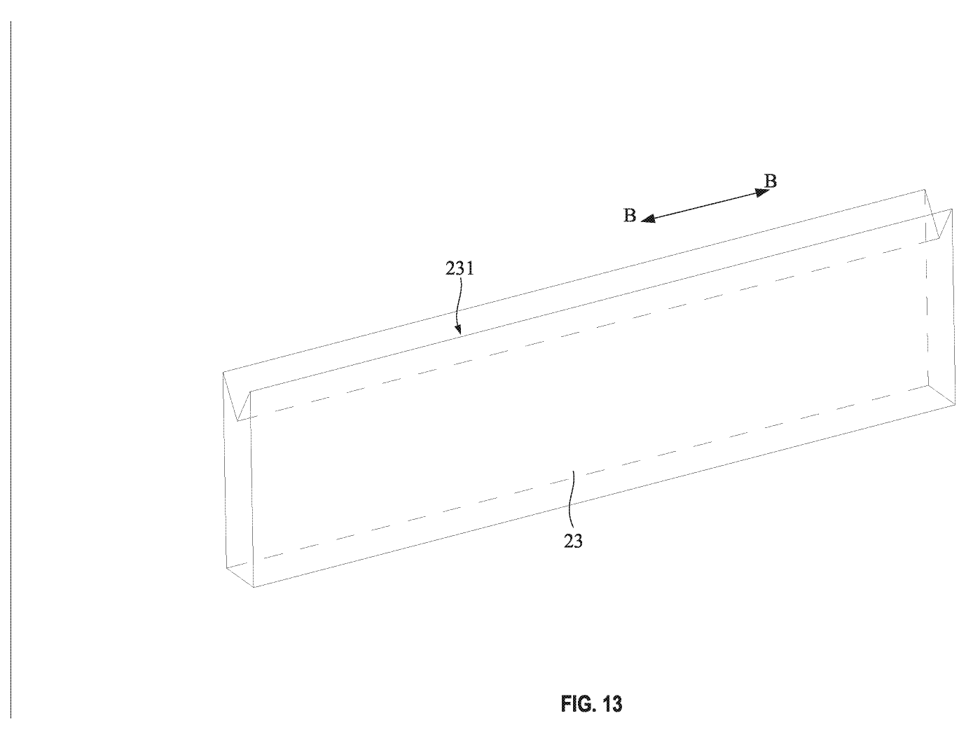

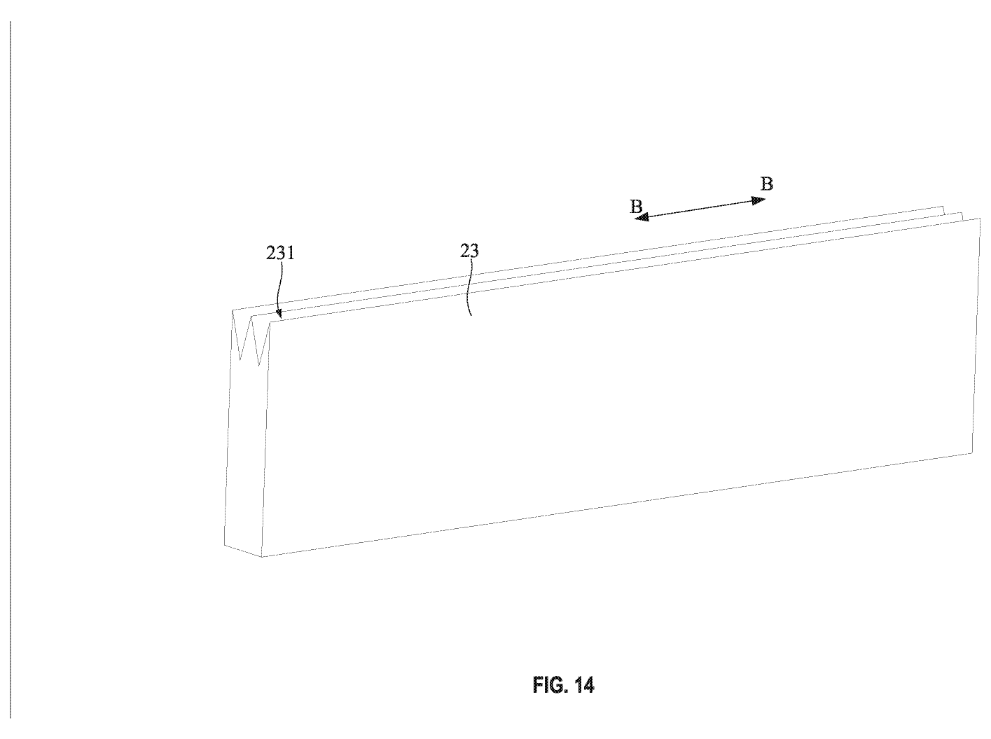

Please refer to FIGS. 13 and 14. For example, the end surface of the top end has one or more conical grooves 231 concave toward the light-exiting surface 211. In this way, when attached substances such as rainwater or dust fall onto the light-blocking member 23, since the end surface of the top end of the light-blocking member 23 has one or more conical grooves 231 concave toward the light-exiting surface 211, the attached substances can be concealed within the conical grooves 231, reducing the reflection of laser light by the attached substances to the receiving lens 222, thereby reducing the generation of stray light. Moreover, the attached substances concealed within the conical grooves 231 can flow out from both sides along the length extension direction BB of the light-blocking member 23, to prevent the attached substances from being stored in the conical grooves 231 of the light-blocking member 23 for a long time.

In some embodiments, a length extension direction BB of the light-blocking member 23 is perpendicular to an optical axis of the transmitting lens assembly 21. It can be understood that the optical axis of the transmitting lens assembly 21 is the emission direction of the laser light emitted by the transmitting lens 212. In this way, when the transmitting lens assembly 21 and the receiving lens assembly 22 are spaced apart, since the length extension direction BB of the light-blocking member 23 is perpendicular to the optical axis of the transmitting lens assembly 21, the light-blocking member 23 can effectively partition mutual interference between the transmitting lens assembly 21 and the receiving lens assembly 22, further reducing the generation of stray light.

In other embodiments, the light-exiting surface 211 and the light-incident surface 221 are coplanar. That is, the light-exiting surface 211 and the light-incident surface 221 are in the same plane. Since the transmitting lens assembly 21 and the receiving lens assembly 22 are spaced apart, the light-blocking member 23 can separate the light-exiting surface 211 and the light-incident surface 221, to block the laser light emitted from the light-exiting surface 211 from incident on the light-incident surface 221, thereby reducing the generation of stray light. Of course, in yet other embodiments, while the length extension direction BB of the light-blocking member 23 is perpendicular to the optical axis of the transmitting lens assembly 21, the light-exiting surface 211 and the light-incident surface 221 are coplanar. The effect is consistent with the above and will not be repeated here.

In some embodiments, a hydrophobic layer is disposed on the light-exiting surface 211, or a hydrophobic layer is disposed on the light-incident surface 221, or hydrophobic layers are disposed on both the light-exiting surface 211 and the light-incident surface 221. The embodiments of the present application do not specifically limit this. The case where hydrophobic layers are disposed on both the light-exiting surface 211 and the light-incident surface 221 is used as an example.

It can be understood that, to reduce the adhesion of attached substances on the light-exiting surface 211 or the light-incident surface 221, a coating treatment is applied to the surfaces of the light-exiting window plate 213 and the light-incident window plate 223 to form hydrophobic layers. The hydrophobic layers have functions of waterproofing and self-cleaning. That is, the hydrophobic layers can significantly reduce the wettability of water molecules on the surfaces of the light-exiting window plate 213 and the light-incident window plate 223, causing water vapor to form droplets and roll off, thereby reducing interference from impurities such as rainwater and dust on laser transmission, and thus improving the detection accuracy of the LiDAR 1. Furthermore, when the LiDAR 1 performs detection in harsh environments, the hydrophobic layers can also protect the light-exiting window plate 213 and the light-incident window plate 223 from erosion by rainwater and dust, thereby extending the service life of the LiDAR 1.

It should be noted that the embodiments of the present application do not specifically limit the material of the hydrophobic layer. For example, the hydrophobic layer may include one of an organic silicon layer, an organic fluorine layer, and a nano-metal oxide layer. It can be understood that, to form hydrophobic layers on the light-exiting surface 211 and the light-incident surface 221, special hydrophobic coating treatments need to be applied to the surfaces of the light-exiting window plate 213 and the light-incident window plate 223, using materials such as organic silicon, organic fluorine, nano-metal oxides, etc. Among them, organic silicon materials have characteristics such as being colorless, transparent, heat-resistant, and corrosion-resistant, which can reduce the adhesion of impurities such as rainwater and dust on the light-exiting window plate 213 or the light-incident window plate 223, thereby keeping the light-exiting window plate 213 and the light-incident window plate 223 clean. In addition, the organic silicon layer can also provide certain flexibility and durability, protecting the optical elements in the LiDAR 1 from damage by the external environment. Organic fluorine materials are used to make hydrophobic layer materials due to their excellent properties such as chemical resistance, high and low temperature resistance, and aging resistance. Nano-metal oxides have unique nanostructures and chemical properties, and the nano-metal oxide layer can also increase the hardness of the metal surface, extending the service life of the LiDAR 1.

Further, in some embodiments, a contact angle of the hydrophobic layer is greater than 90 degrees. It can be understood that the contact angle of the hydrophobic layer refers to the contact angle formed when attached substances such as rainwater or dust come into contact with the light-exiting window plate 213 or the light-incident window plate 223. When the contact angle is greater than 90 degrees, it indicates that the surfaces of the light-exiting window plate 213 or the light-incident window plate 223 have hydrophobic properties, thereby reducing the adhesion of impurities such as rainwater and dust, and thus improving the detection accuracy of the LiDAR 1.

In some embodiments, a hydrophilic layer is disposed on at least a surface of a portion of the light-blocking member 23 protruding from the light-exiting surface 211 and the light-incident surface 221. It can be understood that, to reduce the probability of stray light reflection by attached substances when laser light passes by the light-blocking member 23, the embodiments of the present application provide a hydrophilic layer on at least the surface of the portion of the light-blocking member 23 protruding relative to the light-exiting surface 211 and the light-incident surface 221. The main function of the hydrophilic layer is to form a uniform water film when encountering moisture, rather than forming water droplets. Such a design can, on the one hand, prevent moisture from condensing into water droplets, thereby reducing the formation of stray light; on the other hand, it can reduce the scattering and absorption of laser light, thereby ensuring that the LiDAR 1 can accurately receive and analyze the reflected laser signal.

In rainy, snowy, or humid environments, providing a hydrophilic layer on at least the surface of the portion of the light-blocking member 23 protruding from the light-exiting surface 211 and the light-incident surface 221 can keep the surfaces of the light-exiting window plate 213 and the light-incident window plate 223 clean and dry, thereby improving their environmental adaptability. At the same time, the hydrophilic layer can prevent moisture from corroding and damaging the internal components of the LiDAR 1, thereby extending its service life.

It should be noted that the hydrophilic layer of the embodiments of the present application may include one of a passivation layer, an anodized layer, and a paint layer. That is, to form a hydrophilic layer on at least the surface of the portion of the light-blocking member 23 protruding from the light-exiting surface 211 and the light-incident surface 221, the surface of at least the protruding portion of the light-blocking member 23 can be subjected to passivation, anodization, or paint spraying treatment. The embodiments of the present application do not specifically limit this.

Further, in some embodiments, a contact angle of the hydrophilic layer is less than 60 degrees. The contact angle of the hydrophilic layer is an important indicator for measuring the wettability of the surface of the light-blocking member 23, reflecting the spreading ability of liquid on the surface of the light-blocking member 23. When the contact angle of the hydrophilic layer is less than 60 degrees, it can be considered that the surface of the light-blocking member 23 has strong hydrophilicity. This design of the contact angle of the hydrophilic layer helps moisture form a continuous, uniform water film on the surface of the light-blocking member 23, rather than forming dispersed water droplets. This can effectively reduce the interference of moisture on the laser beam, improving the ranging accuracy and reliability of the LiDAR 1.

Please refer to FIGS. 2 and 3. In some embodiments, the transceiver module 20 further includes a bracket 24. The transmitting lens 212, the light-exiting window plate 213, the receiving lens 222, and the light-incident window plate 223 are all mounted on the bracket 24, allowing the bracket 24 to serve the functions of fixing, supporting, and protecting the transmitting lens assembly 21 and the receiving lens assembly 22. Therefore, the bracket 24 is typically made of high-strength and high-stability materials to ensure that the bracket 24 can long-term withstand the weight of the transmitting lens assembly 21 and the receiving lens assembly 22 as well as the influence of the external environment. Furthermore, in other embodiments, there exists a high-precision bracket 24, allowing the bracket 24 to perform fine adjustments to the positions of the transmitting lens 212 or the receiving lens 222, to ensure that their spatial positional relationship reaches an optimal state, thereby achieving the best imaging and detection effects.

It should be noted that the embodiments of the present application do not specifically limit the manner in which the transmitting lens 212, the light-exiting window plate 213, the receiving lens 222, and the light-incident window plate 223 are mounted on the bracket 24. That is, the transmitting lens 212 and the receiving lens 222 can be mounted on the bracket 24 by screws, adhesive, pressing plates, etc. For example, a plurality of mounting holes 241 can be provided on the bracket 24. The transmitting lens 212 and the light-exiting window plate 213 are mounted in one mounting hole 241, and the receiving lens 222 and the light-incident window plate 223 are mounted in another mounting hole 241.

Further, the light-blocking member 23 and the bracket 24 can be an integrated component, or they can be separate components. The embodiments of the present application do not specifically limit this.

For example, when the light-blocking member 23 and the bracket 24 are an integrated component; that is, the light-blocking member 23 and the bracket 24 can be formed as an integrated component through processes such as injection molding, to reduce the assembly steps of the light-blocking member 23 and the bracket 24 and improve assembly stability and efficiency.

For example, the light-blocking member 23 and the bracket 24 are separate components. That is, the light-blocking member 23 and the bracket 24 can be mounted on the bracket 24 by means such as adhesive bonding or screw connection, to improve the stability of the connection between the light-blocking member 23 and the bracket 24. Moreover, if the light-blocking member 23 or the bracket 24 is damaged, only the damaged part needs to be replaced, saving the cost of replacement materials.

Further, in some embodiments, the light-exiting window plate 213 and the light-incident window plate 223 can be fixed to the bracket 24 by adhesive bonding or pressing plates. This can ensure that the light-exiting window plate 213 and the light-incident window plate 223 are stably and precisely mounted on the bracket 24, thereby ensuring accurate emission and reception of laser light. Connecting the light-exiting window plate 213 and the light-incident window plate 223 to the bracket 24 by adhesive bonding can ensure unobstructed transmission of laser light, while the adhesive can fill tiny gaps between the light-exiting window plate 213 and the light-incident window plate 223 and the bracket 24, improving sealing. Connecting the light-exiting window plate 213 and the light-incident window plate 223 to the bracket 24 by pressing plates facilitates, on the one hand, the disassembly and replacement of the light-exiting window plate 213 or the light-incident window plate 223; on the other hand, appropriate pressure can be applied to the light-exiting window plate 213 or the light-incident window plate 223 to make them suitable for different working environments and requirements.

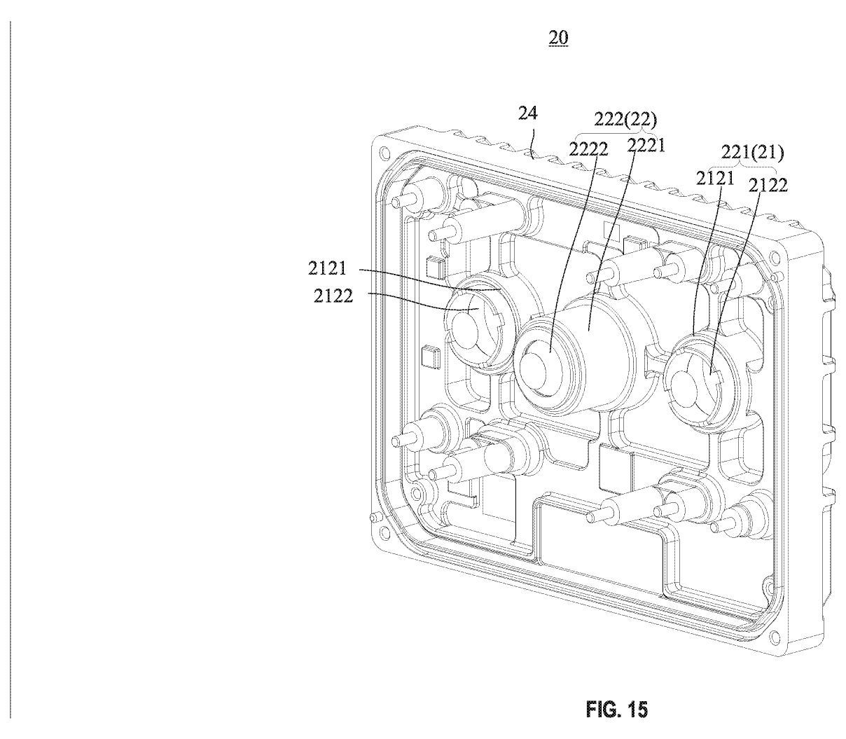

Please refer to FIG. 15. In the above, the formation of the light-exiting surface 211 and the light-incident surface 221 is achieved through the light-exiting window plate 213 and the light-incident window plate 223. In other embodiments, the light-exiting surface 211 and the light-incident surface 221 can be formed in other ways. For example, the transmitting lens assembly 21 includes a transmitting lens 212. The transmitting lens 212 is located on the transmission path of the detection laser signal emitted by the transmitter. The transmitting lens 212 includes a transmitting lens barrel 2121 and a light-exiting lens 2122. The light-exiting lens 2122 is mounted in the transmitting lens barrel 2121. That is, the light-exiting lens 2122 can be fixed in the transmitting lens barrel 2121 by screws, pressing plates, etc. The embodiments of the present application do not specifically limit this. Furthermore, an outer surface of the outermost light-exiting lens 2122 is the light-exiting surface 211. That is, the number of light-exiting lenses is at least one, and the outer surface of the outermost light-exiting lens 2122 forms the light-exiting surface 211.

The receiving lens assembly 22 includes a receiving lens 222. The receiving lens 222 is located on the transmission path of the echo signal received by the receiver. The receiving lens 222 includes a receiving lens barrel 2221 and a light-incident lens 2222. The light-incident lens 2222 is mounted in the receiving lens barrel 2221. That is, the light-incident lens 2222 can be fixed in the receiving lens barrel 2221 by screws, pressing plates, etc. The embodiments of the present application do not specifically limit this. Furthermore, an outer surface of the outermost light-incident lens 2222 is the light-incident surface 221. That is, the number of light-incident lenses is at least one, and the outer surface of the outermost light-incident lens 2222 forms the light-incident surface 221.

Further, the light-blocking member 23 includes a portion of the transmitting lens barrel 2121 protruding from the light-exiting surface 211, or the light-blocking member 23 includes a portion of the receiving lens barrel 2221 protruding from the light-incident surface 221; or the light-blocking member 23 includes a portion of the transmitting lens barrel 2121 protruding from the light-exiting surface 211, and the light-blocking member 23 includes a portion of the receiving lens barrel 2221 protruding from the light-incident surface 221. The embodiments of the present application do not specifically limit this. The case where the light-blocking member 23 includes a portion of the transmitting lens barrel 2121 protruding from the light-exiting surface 211 is used as an example for description.

It can be understood that since the transmitting lens barrel 2121 itself is cylindrical, after the light-exiting lens is installed in the transmitting lens barrel 2121 and the outer surface of the outermost light-exiting lens 2122 forms the light-exiting surface 211, the edge of the transmitting lens barrel 2121 itself protruding from the light-exiting surface 211 can form the light-blocking member 23, to block laser light from being reflected to the light-incident surface 221, thereby reducing the generation of stray light.

Further, based on the transceiver module 20 further including the bracket 24, in some embodiments, both the transmitting lens 212 and the receiving lens 222 can be mounted on the bracket 24. That is, the transmitting lens 212 and the receiving lens 222 can be mounted on the bracket 24 by screw connection, pressing plates, etc. The embodiments of the present application do not specifically limit this.

At this time, to reduce the generation of stray light, along the light-exiting direction of the transmitting lens 212, a first distance exists between the light-exiting surface 211 and the bracket 24, and the first distance is not less than 2mm. That is, the first distance can be 2mm, 3mm, 4mm, etc., so that the bracket 24 serves as the light-blocking member 23, thereby reducing the generation of stray light and improving the detection accuracy of the LiDAR 1.

Based on the transmitting lens assembly 21 including the transmitting lens 212 and the receiving lens assembly 22 including the receiving lens 222, in some embodiments, the transceiver module 20 may further include a shared window plate. The shared window plate is disposed on the light-exiting side of the transmitting lens 212 and the light-incident side of the receiving lens 222 and has the light-exiting surface 211 and the light-incident surface 221. That is, the shared window plate is a single piece and is disposed as a whole on the light-exiting side of the transmitting lens 212 and the light-incident side of the receiving lens 222. It can also be understood as combining the aforementioned light-exiting window plate 213 and light-incident window plate 223 into one integral unit.

Further, the light-blocking member 23 penetrates the shared window plate, and the light-blocking member 23 protrudes relative to both the light-exiting surface 211 and the light-incident surface 221. The light-blocking member 23 is located between the transmitting lens 212 and the receiving lens 222. It can be understood that when the window plate is a single piece, to block the laser light emitted from the light-exiting surface 211 from incident on the light-incident surface 221, the light-blocking member 23 is provided to partition the shared window plate into at least one light-exiting window plate 213 and at least one light-incident window plate 223. The light-blocking member 23 can extend along the light-exiting direction of the transmitting lens 222, so that the light-blocking member 23 penetrates the shared window plate, thereby realizing that the light-blocking member 23 protrudes relative to the side of the shared window plate away from the transmitting lens 222, serving to block the laser light emitted from the light-exiting surface 211 from incident on the light-incident surface 221. This solves the problem of stray light formed by reflection of emitted light by attached substances such as rainwater, while also solving the problem of optical waveguides formed by emitted laser light within the window plate.

Based on the embodiment with the shared window plate, the shared window plate can abut against the transmitting lens barrel 2121. With such an arrangement, a portion of the transmitting lens barrel 2121 can protrude relative to the surface of the outermost lens of the transmitting lens 212, and a portion of the receiving lens barrel 2221 can protrude relative to the surface of the outermost lens of the receiving lens 222. In this way, when the LiDAR 1 operates, the laser light emitted by the transmitting lens 212 is blocked by the protruding portion of the transmitting lens barrel 2121, and the protruding portion of the receiving lens barrel 2221 can also block part of the stray light, reducing the probability of laser light emitted by the transmitting lens 212 incident into the adjacent receiving lens 222.

In yet other embodiments, the transmitting lens 212 may not include the transmitting lens barrel 2121, and the receiving lens 222 may not include the receiving lens barrel 2221. The bracket 24 forms a transmitting cavity, and the lens of the transmitting lens 212 is installed in the transmitting cavity. The bracket 24 forms a receiving cavity, and the lens of the receiving lens 222 is installed in the receiving cavity. Moreover, a portion of the bracket 24 protrudes relative to the surface of the outermost lens of the transmitting lens 212 and relative to the surface of the outermost lens of the receiving lens 222. In this way, when the LiDAR 1 operates, the laser light emitted by the transmitting lens 212 is blocked by the protruding portion of the bracket 24, and the protruding portion of the bracket 24 can also block part of the stray light, reducing the probability of laser light emitted by the transmitting lens 212 incident into the adjacent receiving lens 222.

In the drawings of this embodiment, the same or similar reference numerals correspond to the same or similar components. In the description of the present application, it should be understood that if there are terms such as "upper," "lower," "left," "right," etc., indicating orientation or positional relationships, they are based on the orientation or positional relationships shown in the accompanying drawings. They are merely for the convenience of describing the present application and simplifying the description, rather than indicating or implying that the referred device or element must have a specific orientation or be constructed and operated in a specific orientation. Therefore, the terms describing positional relationships in the drawings are for illustrative purposes only and should not be construed as limiting the present application. Those of ordinary skill in the art can understand the specific meanings of the above terms according to specific circumstances.

The above are only some embodiments of the present application and are not intended to limit the present application. Any modifications, equivalent replacements, and improvements made within the spirit and principles of the present application shall be included within the protection scope of the present application.

What is claimed is:

1. A transceiver module, applied to a LiDAR, comprising:
at least one transmitting lens assembly having a light-exiting surface;
at least one receiving lens assembly having a light-incident surface, spaced apart from the transmitting lens assembly, wherein a receiving field of view of the receiving lens assembly and a transmitting field of view of the transmitting lens assembly have an overlapping region; and
a light-blocking member, located between the light-exiting surface and the light-incident surface, and at least partially located in the overlapping region and disposed adjacent to at least one of the light-exiting surface or the light-incident surface, so as to block laser light emitted from the light-exiting surface from incident on the light-incident surface.

2. The transceiver module according to claim 1, wherein:
the transmitting lens assembly comprises a transmitting lens and a light-exiting window plate disposed on a light-exiting side of the transmitting lens, a surface of the light-exiting window plate facing away from the transmitting lens is the light-exiting surface; and
the receiving lens assembly comprises a receiving lens and a light-incident window plate disposed on a light-incident side of the receiving lens, a surface of the light-incident window plate facing away from the receiving lens is the light-incident surface,
wherein the light-exiting window plate and the light-incident window plate are spaced apart, the light-blocking member is disposed between the light-incident window plate and the light-exiting window plate, and protrudes relative to both the light-exiting surface and the light-incident surface.

3. The transceiver module according to claim 2, wherein:
a protruding height of the light-blocking member relative to the light-exiting surface is not greater than 3 mm; or
a protruding height of the light-blocking member relative to the light-incident surface is not greater than 3 mm.

4. The transceiver module according to claim 2, wherein: the light-blocking member has a top end protruding relative to the light-exiting surface, an end surface of the top end is an arc-shaped surface or a conical surface protruding away from the light-exiting surface, or the end surface of the top end has one or more arc-shaped grooves concave toward the light-exiting surface, or the end surface of the top end has one or more conical grooves concave toward the light-exiting surface.

5. The transceiver module according to claim 2, wherein: an extending direction of a length of the light-blocking member is perpendicular to an optical axis of the transmitting lens assembly; or
the light-exiting surface and the light-incident surface are coplanar.

6. The transceiver module according to claim 2, wherein: a hydrophobic layer is disposed on at least one of the light-exiting surface or the light-incident surface.

7. The transceiver module according to claim 6, wherein:
the hydrophobic layer comprises one of an organic silicon layer, an organic fluorine layer, and a nano-metal oxide layer; and
a contact angle of the hydrophobic layer is greater than 90 degrees.

8. The transceiver module according to claim 2, wherein: a hydrophilic layer is disposed on at least a surface of a portion of the light-blocking member protruding from the light-exiting surface and the light-incident surface.

9. The transceiver module according to claim 8, wherein:
the hydrophilic layer comprises one of a passivation layer, an anodized layer, and a paint layer; and
a contact angle of the hydrophilic layer is less than 60 degrees.

10. The transceiver module according to claim 2, further comprising:
a bracket, wherein the transmitting lens, the light-exiting window plate, the receiving lens, and the light-incident window plate are all mounted on the bracket,
wherein the light-blocking member and the bracket are an integrated component or the light-blocking member and the bracket are separate components, and the light-blocking member is mounted on the bracket.

11. The transceiver module according to claim 10, wherein: the light-exiting window plate and the light-incident window plate are fixed to the bracket by adhesive bonding or pressing.

12. The transceiver module according to claim 1, wherein the transmitting lens assembly comprises a transmitting lens, the receiving lens assembly comprises a receiving lens, and the transceiver module further comprises:
a shared window plate, disposed on a light-exiting side of the transmitting lens and a light-incident side of the receiving lens, and having the light-exiting surface and the light-incident surface,
wherein the light-blocking member penetrates the shared window plate, protrudes relative to both the light-exiting surface and the light-incident surface, and is located between the transmitting lens and the receiving lens.

13. The transceiver module according to claim 1, wherein:
the transmitting lens assembly comprises a transmitting lens, the transmitting lens comprises a transmitting lens barrel and a light-exiting lens mounted in the transmitting lens barrel, an outer surface of an outermost light-exiting lens is the light-exiting surface; and
the receiving lens assembly comprises a receiving lens, the receiving lens comprises a receiving lens barrel and a light-incident lens mounted in the receiving lens barrel, an outer surface of an outermost light-incident lens is the light-incident surface,
wherein the light-blocking member comprises a portion of the transmitting lens barrel protruding from the light-exiting surface, or the light-blocking member comprises a portion of the receiving lens barrel protruding from the light-incident surface.

14. The transceiver module according to claim 13, further comprising:
a bracket, wherein the transmitting lens and the receiving lens are both mounted on the bracket,
wherein along a light-exiting direction of the transmitting lens, a first distance exists between the light-exiting surface and the bracket, and the first distance is not less than 2 mm.

15. The transceiver module according to claim 1, wherein at least one of the transmitting lens assembly or the receiving lens assembly is plural in number; and
when the number of the transmitting lens assemblies is two, the two transmitting lens assemblies are located on opposite sides of one receiving lens assembly, and one light-blocking member is located between one light-exiting surface and the light-incident surface, and another light-blocking member is located between the other light-exiting surface and the light-incident surface.

16. A LiDAR, comprising:
a housing; and
the transceiver module according to claim 1, the transceiver module being mounted on the housing.
